(19) United States
(12) Patent Application Publication
(10) Pub. No.: US 2004/0142482 A1
(43) Pub. Date: Jul. 22, 2004

(54) High-resolution ellipsometry method for quantitative or qualitative analysis of sample variations, biochip and measuring device

(76) Inventors: Peter Westphal, Jena (DE); Matthias Eberhardt, Ulm (DE)

Correspondence Address: Daniel J Hudak Jr, Hudak Shunk & Farine Company, Suite 307, 2020 Front Street, Cuyahoga Falls, OH, 44221, US

(21) Appl. No.: 10/478,574

(22) PCT Filed: May 29, 2002
(86) PCT No.: PCT/EP02/05895

(30) Foreign Application Priority Data
May 30, 2001 (DE) 101 26 152.7

(51) Int. Cl. G01N 21/00

(52) U.S. Cl. 436/164; 422/82.05

(57) ABSTRACT

This invention relates to a high-resolution ellipsometry method for quantitative and/or qualitative analysis of sample variations. The sample is located on a sample carrier, equipped with at least one metal film. The parameters ψ and Δ are determined by ellipsometric measurement, wherein the angle of incidence and/or frequency of the electromagnetic radiation used in ellipsometric measurements is set in such a way as to produce a damped surface plasmon resonance. The detection sensitivity (sample variation unit) is adjusted by means of the thickness of the metal layer. The electromagnetic radiation is planely radiated onto the side of the sample carrier opposite the sample. Using at least one angle of incidence and one frequency at least two staggered, simultaneous, high-resolution ellipsometric measurements are taken of the sample or samples. At least the corresponding Δ or cos Δ value are evaluated to determine sample variation. The invention also relates to a biochip having a base plate with at least one metal layer and a measuring device having an ellipsometer with a radiation source (2), a polarizer (6), an analyzer (7) and a detector (9), which is an image-providing sensor. A lens system (5,8) is arranged in the beam path, behind and in front of the biochip coupling and decoupling device (20), which planely illuminates said coupling and decoupling device and the detecting surface of the detector (9). The invention further relates to an evaluation unit (10) that carries out simultaneous high-resolution processing of the measurement signals and at least for simultaneous high-resolution evaluation of the values δ cos Δ.

The invention relates to a method for quantitative and/or qualitative determination of sample variations due to chemical, biological, biochemical or physical effects based on a change in the refraction index and/or the change in the layer thickness of the sample in accordance with claim 1. The invention further relates to the use of this method and to a corresponding measuring device in accordance with the preamble of claim 28. The invention also relates to a biochip in accordance with the preamble of claim 11.

Biological and chemical interactions taking place in liquid-filled cuvettes while forming thin films have thus far been detected by labeling the substances involved, e.g. by fluorescent or radioactive molecules, among other methods. This is described, for example, in S. S. Deshpande, “Enzyme Immunoassays—From Concept to Product Development,” Chapman & Hall, 1996. These methods have the advantage of being relatively simple to execute but involve a number of drawbacks. For example, the relevant molecules must first be labeled or purchased in labeled form. These preparations are not only time-consuming but the labeling may also influence the biological or chemical interactions, which in turn affects the measuring results. The problems involved in handling radioactive material are a further drawback.

For this reason, the trend is to switch to direct measurement methods that require no labeling at all. In this connection, two methods have proven to be suitable.

In surface plasmon resonance measurements, the resonance of free electrons present in metal is excited in approximately 50-60 nm thick metal films, particularly gold or silver films (see E. Gedig, D. Trau and M. Orban, “Echtzeitanalyse biomolekularer Wechselwirkungen” [Real-Time Analysis of Biomolecular Interactions], Laborpraxis, February 1998, pp. 26-28 and 30). This excitation of the free electrons occurs only if light polarized parallel to the angle of incidence is applied. For each measurement, it is necessary to pass through either the angle of incidence or the light frequency used. As a result, the apparatus becomes relatively complex. The reflected intensity as a function of the wavelength at a fixed angle, or the angle of incidence at a fixed wavelength, shows a minimum in the resonance region.

Because the electromagnetic radiation when reflected does not remain limited to the thin metal film but interacts with the first, approximately 100 to 300 nm thick layer of the superjacent medium across the so-called evanescent field, the resonance angle or the resonance wavelength is strongly influenced by the refraction index of the layer directly superjacent to the metal layer. If the resonance conditions change, e.g. because small amounts of water are replaced as a result of biological or chemical reactions while forming an additional layer, the minimum of the reflected intensity shifts. This shift can be used only to detect the qualitative growth of the layer but not its absolute thickness, because this would require knowing the refraction index of the growing layer. Thus, in addition to the substantial complexity of the apparatus, the measuring result is not very informative. A corresponding measuring device is described, for example, in WO 90/05295.

The second method is ellipsometry. Here, the light is applied in such a way that it passes through a gaseous or liquid ambient medium and then strikes the biological or chemical layer to be detected (see H. Arwin, “Spectroscopic ellipsometry and biology: recent developments and challenges,” Thin Solid Films 313-314, 1998, pp. 764-774).

In ellipsometric measurements, the ellipsometric parameters ψ and Δ are determined, for which the following holds:

rₚ/rₛ=(Eᵣₚ/E_{?p})(E_{??}/E_{??})=tan ψ·exp (iΔ)

rₚ, rₛ: complex reflectivities

E: complex electric field amplitude

Indices:

p: parallel to the plane of incidence

s: perpendicular to the plane of incidence

e: radiated

r: reflected

ψ essentially includes the change in intensity due to the reflection of the light. Δ essentially includes the phase shift due to the reflection of the light; this parameter is very sensitive to layer thicknesses.

EP 0 067 921 discloses a method for determining bioactive substances using ellipsometric measurements. A thin dielectric substrate is coated with an immobilization layer consisting of a first biologically active substance that interacts with a second bioactive substance. Ellipsometric measurements are used to detect the optical changes in the biological layer. For the analysis, the ellipsometric parameters are plotted as a function of time and these curves are compared with reference curves from measurements taken on biological material of known concentrations. Although radiation through the rear side of the substrate was taken into consideration, the sensitivity of the measurement obtained with radiation from the rear was 30× poorer than with radiation from the front. As a result, this prior art method has the drawback that special cuvettes must be used and titer plates cannot be used at all.

In Sensors and Actuators B 30 (1996), pp. 77-80, it is proposed to examine the polarization state of the reflected light to detect DNA samples that are immobilized on a metal film. A metal film without DNA molecules is examined as a reference. Both p-polarized and s-polarized light are applied, and the phase shift between the samples and the reference signal is analyzed. Instead of examining the angular dependence of the intensity, as in known surface plasmon measurements, the angular dependence of the polarization state is considered here. When implemented in practice, this would again result in a complex apparatus because of the changes in the angle of incidence that would be required here.

The unpublished German application DE 100 06 083.8 describes a method using an ellipsometric measurement in which the ellipsometric parameters ψ and Δ are established to determine quantitatively and/or qualitatively the layer thicknesses of the biological or chemical molecules being deposited due to interactions from a gaseous or liquid medium onto a metal film provided with an immobilization layer. The angle of incidence and/or the frequency of the electromagnetic radiation used for the ellipsometric measurements are adjusted such that a surface plasmon resonance is produced in the metal layer.

The detection sensitivity (δcos Δ/thickness of the layer to be determined) is adjusted via the thickness of the metal layer. The electromagnetic radiation is directed onto the side of the metal layer opposite the immobilization layer.

At least one ellipsometric measurement is carried out during or after deposition and at least the corresponding cos Δ value is analyzed to determine the change in the thickness of the layer to be detected.

This method has the drawback that only individual samples can be tested. Testing of a large number of samples is time consuming because the individual samples must be successively brought into the beam path of the measuring device. This method cannot be used to test a plurality of samples simultaneously.

In biological applications, however, many samples must be tested in a short time, particularly in biological processes that are based on intermolecular coupling reactions, also referred to as biomolecular interactions. For example, the curative effect of antibodies in the human body is based on the fact that these antibodies detect harmful objects (proteins, viruses, bacteria, pollen, etc.) and render them harmless. As a rule, the detection response follows a lock-key principle, i.e. the antibody locks specifically onto the harmful object. The process is similar with many drugs whose ingredients are adsorbed to and act at specific sites in the body. The more specifically the drug is adsorbed, the more specifically it can act. The search for new drugs is therefore closely linked with the task of determining the molecular interactions of many different substances (drug screening).

Particularly promising in this connection are genetic engineering approaches in which the DNA and the RNA are of central importance. To be able to utilize, for example, the knowledge of the human genome, the function of individual DNA sequences must first be determined. This requires, among other things, recognizing the differences between the DNA sequences of healthy and sick individuals. Methods exist for specifically immobilizing on surfaces different DNA strands of specific length and base pairs. So-called DNA arrays or DNA chips with a matrix-like arrangement of DNA spots are used for this purpose. The DNA strands can be placed, for example, using piezoelectric methods or can be synthesized directly on the chip surface using photolithographic methods.

Using so-called hybridization reactions (two individual, mutually complementary DNA or RNA strands form a double strand) it can be determined, for example, where the differences occur between healthy and illness-inducing DNA fragments. Further, there are interactions between DNA and, respectively, RNA fragments and proteins, since DNA and RNA control protein production in cells, which is also referred to as transcription or translation. So-called cDNA arrays are used to investigate the question as to which DNA is transcribed into mRNA.

If a DNA helix is immobilized on a surface such that the axis of the helix is approximately perpendicular to the surface, the height per base pair is between approximately 0.2 nm and 0.4 nm, depending on the type of the helix. The number of base pairs on DNA chips is usually 8 to 25, so that a strand height of approximately 2 to 8 nm is obtained. The diameter of the helix is approximately 1.8 to 2.6 nm. Depending on the DNA packing density, the average layer thickness can also be clearly below 1 nm, which requires a correspondingly sensitive detection method.

Typically, a few hundred to a few thousand different base sequences are applied to a DNA chip. A so-called spot contains a certain number of DNA strands with an identical base sequence. Even for a comparatively small number of eight bases per strand, thousands of spots have to be applied to take into account all the possible base sequences. Detection of hybridization thus requires a sensitive measuring method that can be used to simultaneously analyze as many spots as possible.

In other biochemical interactions, such as, for example, antibody-antigen reactions, it is of great interest to determine the coupling strength because this can yield new approaches to new pharmaceutical products.

The coupling reactions being considered here lead to an increase in mass on a surface, which is associated with a change in the refraction index in the immediate vicinity of that surface. This change in the refraction index can in principle be measured. Currently, however, so-called fluorescent readers are primarily used to detect the aforementioned biochemical reactions. Fluorescence readers, however, are not capable of measuring an increase in mass directly but require the molecules to be marked by a fluorescent label.

Fluorescent labels, however, have the drawback that they fade after a short time, which makes quantitative analyses more difficult. As a rule, highly sensitive low-noise CCD cameras are required for detection, which must be cooled to correspondingly low temperatures.

Graham Ramsey in “DNA-Chips: State of the Art,” Nature Biotechnology, Vol. 16, January 98, pp. 40 to 44, describes various kinds of DNA chips.

The base plate of such DNA chips is made, for example, of silicon. To accelerate the hybridization process of labeled samples, these chips may also be provided with microelectrodes.

Steel et al., in “Electrochemical Quantitation of DNA Immobilized on Gold,” Analytical Chemistry, Vol. 70, No. 22, Nov. 15, 1998, describe gold films serving as electrodes that are sputtered onto glass bodies. This document does not describe DNA chips that are adapted for use in sensitive optical measuring methods.

It is one object of the invention to provide a method that ensures rapid and simultaneous measurement of a large number of samples and, at the same time, greater detection sensitivity, enabling not only qualitative but also quantitative detection of sample variations. A further object of the invention is to provide a corresponding measuring device for carrying out this method. Finally, it is an object of the invention to provide biochips adapted for use in this method and the measuring device.

These objects are attained by a method for quantitative and/or qualitative determination of sample variations due to chemical, biological, biochemical or physical effects based on a change in the refraction index of the sample. The sample is located on a sample carrier provided with at least one metal film. Ellipsometric measurements are used to determine the ellipsometric parameters ψ and Δ, wherein

the angle of incidence and/or the frequency of the electromagnetic radiation used for the ellipsometric measurements are set in such a way as to produce a damped surface plasmon resonance (SPR) in the metal film,

the detection sensitivity (δ cos Δ)/(sample variation unit) is adjusted via the thickness of the metal film,

the electromagnetic radiation is directed two-dimensionally onto the side of the sample carrier opposite the sample and

using at least one angle of incidence and at least one frequency, at least two time-staggered, simultaneous, spatially resolved ellipsometric measurements are taken of the sample or samples and at least the corresponding Δ or cos Δ values are evaluated to determine the sample variation.

The invention is suitable for detecting all physical, chemical, biological or biochemical processes in which the refraction index near a surface changes sufficiently. In particular, it is suitable for the above-described coupling reactions on a flat biochip, as will be described in greater detail below.

Sample variations should be understood to mean, in particular, the growth of layers of biological or chemical molecules deposited from a fluid onto an immobilization layer, particularly the initially described changes based on biochemical interactions, but also physical changes, such as, for example, the shrinkage or swelling of polymer films.

It has been shown that the ellipsometric parameter Δ is strongly influenced by surface plasmon excitation. If the wavelength and/or the angle of incidence of the electromagnetic radiation used is adjusted in relation to the employed metal such that a surface plasmon excitation occurs, the detection sensitivity is significantly increased and is on an order of magnitude greater than that afforded by conventional ellipsometry, i.e. without excitation of the surface plasmons.

This makes it possible, for example, to detect substantially smaller changes in layer thicknesses or to detect earlier the growth of layers as a result of biological or chemical interactions.

Whereas in the prior art, radiation from the back without a metal film yields poor ellipsometric measuring results, this drawback is not found in the method according to the invention. This is attributable to the use of a signal amplifying metal layer according to the invention. This makes it possible, for example, to use otherwise conventional cuvettes provided with such a metal coating and to take the measurement on the bottom wall of the cuvette.

Since ellipsometry gives an additional parameter, namely ψ, the refraction index linked to the sample variation does not need to be known in order to determine absolute values. With the method according to the invention it is thus possible to obtain more information with greater accuracy. If, for example, the absolute thickness of the grown layer is to be determined, tan ψ is evaluated in addition to cos Δ.

In contrast to conventional ellipsometry, the method according to the invention makes it possible to further increase the signal height and thus the detection sensitivity if the thickness of the metal film is optimized. By adjusting the thickness of the metal film, it is possible to increase the slope of the cos Δ curve and to increase the ratio of δ cos Δ to sample variation. This may limit the dynamic range with respect to the maximum measurable sample variations since, in principle, the entire cos Δ change cannot be greater than 2. This is not a drawback, however, because if necessary the cos Δ change can also be reduced again via the selection of the film thickness or the light wavelength.

To determine changes in layer thickness or changes in the refraction index, the spectral shift of the tan ψ and cos Δ curves is determined. Using a simulation program, the relative and absolute change in the layer thickness or the refraction index can then be calculated.

If, for example, the layer system to be examined is sufficiently known and is homogenous across the entire detection area, it is also possible to take the measurement at only a single wavelength. In this case, instead of the spectral shift of the tan ψ and the cos Δ curves, the change in the tan ψ and cos Δ values is determined at a fixed wavelength. This assumes, however, that the additional growth in layer thickness or the change in the refraction index is not too large because the dynamic range of the cos Δ value is limited to −1 to +1.

In this case, evaluating one of the two ellipsometric values may be sufficient. For the most part, the cos Δ value proves to be the more sensitive value. The advantage of the method according to the invention is that after setting the parameters for the surface plasmon excitation, it is not absolutely necessary to vary either the wavelength or the angle of incidence. This is a significant advantage with respective to the complexity of the apparatus as compared to measuring methods in which one of these parameters has to be varied. The method according to the invention makes it possible to examine more samples per time unit than has heretofore been the case, because it is no longer necessary systematically to scan the angle of incidence and the wavelength.

Compared to conventional SPR measuring devices this has the advantage that in principle ellipsometric measurements supply more information because they determine two quantities simultaneously (δ and Δ). As a result, more precise quantitative statements can be made regarding changes in layer thickness or changes in the refraction index. For this reason, a coarse spectral resolution is sufficient in the method according to the invention, whereas in spectral SPR measurements, the exact position of a narrow reflection minimum must be found. The measuring device according to the invention is furthermore less sensitive with respect to intensity fluctuations of the light source and the ambient light over time because scaling takes place continuously through the s-polarized light. SPR measurements with angle variations, in contrast to the method according to the invention, are in principle unsuitable for two-dimensional spatially resolved simultaneous measurements because one spatial dimension is already required for determining the angle-dependent reflectivity minimum.

The ellipsometric characterizability of all the layers involved is an inherent advantage of the invention compared to all non-ellipsometric SPR measuring methods.

In contrast to fluorescence-based measuring methods, the invention has the considerable advantage that it enables detection without labeling, making biochemical preparation easier and cheaper. With the method according to the invention, the biological interactions are not distorted by a fluorescent label. Another significant advantage of the invention is that there are no fading effects as in fluorescence-based methods. This fading of the fluorescent dye is a well-known and significant problem in quantitative analyses of coupling reactions. In contrast to fluorescence detectors, the method according to the invention does not require a highly sensitive camera because a significantly larger intensity component of the radiated light is available for detection.

Compared to measuring methods based on radioactive labeling, the advantages are similar to those in comparison with fluorescent labeling. In addition, the handling of radioactive substances can be avoided.

Compared to mass spectroscopic methods, the principle advantage is the substantially reduced complexity of the apparatus because there is no need for vacuum technology. Mass spectroscopic methods supply other experimental data and can therefore complement optical methods.

Because the area of a biochip to be measured is relatively small—usually a few cm²—the entire chip can easily be covered by a single spatially resolved measurement. The method is particularly suited for simultaneously detecting a plurality of biochemical coupling events. For this purpose, a flat biochip provided with a metal coating is loaded with many different capture molecules. These capture molecules, which are immobilized on the metal layer, possibly using a so-called spacer (molecules to achieve favorable steric conditions), are capable of binding to very specific molecules from a solution. The resulting increase in mass on the surface can be measured by means of the associated change in the refraction index. The capture molecules can be, for example, DNA fragments (oligonucleotides), antibodies, amino acid chains (peptides) as well as viruses or bacteria. The capture molecules can be immobilized, for example, by means of streptavidin-biotin bonds, methods involving thiol chemistry or other wet chemical methods.

Another suitable method is to immobilize capture molecules on the titer-plate cuvette bottoms coated with a suitable metal film. Here, all the cuvettes are usually provided with the same type of capture molecules, but different solutions are subsequently placed into each of the cuvettes.

With a corresponding configuration of the invention, the entire titer plate can be measured using one image of the imaging sensor.

Furthermore, kinetic (time-resolved) coupling measurements are made possible as well as measurements of stationary states (as a rule, start and end states). This latter type of measurement is frequently used to examine so-called hits. These are pharmaceutically relevant coupling events that exceed a predefined affinity threshold.

Preferably, the simultaneous, spatially resolved ellipsometric measurements are conducted during as well as before and/or after the sample variations. The measurements before the sample variation serve as reference measurements, which are compared with the measurement or measurements taken during or after the sample variation. The change in cos Δ makes it possible to draw a conclusion regarding the magnitude of the sample variation. The reference measurements can also be used for different samples.

Another preferred embodiment provides that continuous ellipsometric measurements are conducted at least during a time segment of the sample variations and that at least the change over time of the associated cos Δ value is analyzed. These measurements make it possible, for example, to track the growth of the layers to be detected.

Preferably, the metal film used is made of a metal that has a refraction index (real part) of <1 in the wavelength range of the electromagnetic radiation used. Preferred is a metal film made of copper, gold, silver or aluminum or an alloy containing these metals.

In prior-art surface plasmon resonance spectroscopy the metal films used are ≧50 nm. In contrast, thicknesses ranging from 10 to 45 nm, preferably between 10 and 40 nm, have proven to be far more useful for the method according to the invention. With layer thicknesses ≧50 nm, the cos Δ curve is clearly flatter as a function of the radiated light frequency and the dynamic range of between −1 and +1 is not exhausted. On the other hand, with metal layer thicknesses ≦10 nm, the sensitivities are insufficient.

The preferred thickness of the functional partial layer of between 20 nm and 40 nm ensures that the reflectivity collapse is reduced and spectrally broadened in surface plasmon resonance. This physical behavior is referred to as damped surface plasmon resonance (damped SPR). Damped surface plasmon resonance has the result that the ellipsometric values tan ψ and cos Δ do not change abruptly in case of wavelength variations. This has the advantage that the spectral resolution of the entire measuring device can be relatively low, saving both costs and measuring time. As a rule, measuring at a few discrete wavelengths is sufficient to characterize the spectral shape of tan ψ and cos Δ with adequate precision. This characterization is necessary particularly if the layers involved (functional metal layer, bonding layer, biochemical layers, etc.) are not yet precisely known. The ellipsometric characterizability of the layers involved is an inherent advantage compared to non-ellipsometric SPR measuring devices. Preferably, all measurements are taken near the zero crossing of cos Δ on the wavelength scale because the detection sensitivity is greatest at this point.

It is also possible to conduct the ellipsometric measurements on still or flowing media.

Preferably, electromagnetic radiation in the wavelength range of 100 nm to 10 μm, preferably 300 nm to 3 μm is used. Monochromatic radiation, particularly light, is preferred. The advantage of monochromatic radiation is that the radiation does not need to be spectrally filtered prior to detection.

Lasers may be used as radiation sources. It is also possible, however, to use lamps as a radiation source, e.g. xenon lamps with broad spectral distribution. In this case, spectral filtering is advantageously carried out prior to detection. The method is preferably carried out on a biochip provided with a plurality of spots or on a plurality of microreaction vessels of a titer plate.

A preferred use of the method is the examination of biochemical interactions based on DNA or RNA hybridization, DNA or RNA protein interactions, DNA or RNA-antibody interactions or antibody-antigen interactions.

The method can be used for characterizing antibodies, developing immunoassays, optimizing ELISAs (ELISA: enzyme-linked immunoabsorbent assay), determining the concentration of small amounts of analyte, studying membranes or for investigating signal transduction chains.

The method is also suitable for examining physical or chemical sample variations in which the characteristics (complex refraction index, layer thickness, optical anisotropy, etc.) of thin films are spatially resolved. The method can be used, for example, to investigate the shrinkage or swelling of polymer layers. It is also possible to determine the complex refraction index of liquids or polymerized solids. Further, the changes in concentration of ions, glucose or other ingredients in a liquid can also be determined.

For example, the development over time of the diffusion process of soluble substances can be tracked with two-dimensional spatial resolution.

A biochip adapted for use with this method has a sample carrier with a base plate provided with at least one metal film. The sample carrier is made of a material that has a transmission of at least 20% in the electromagnetic wavelength range of between 100 nm and 10 μm, at least in a wavelength segment having a width of at least 10 nm. The metal film is preferably made of copper, silver, gold or aluminum alloy or an alloy containing at least 5 percent by weight of at least one of these metals. The thickness of the metal layer, or the total thickness of several metal layers, is between 10 and 45 nm, preferably between 20 and 40 nm.

Biochips are defined as DNA chips, RNA chips, electrophoresis chips and protein chips. DNA or RNA chips also include the so-called DNA arrays, which are provided with a plurality of spots. DNA chips with only a single sample substance are also included.

The base plate of the sample carrier is preferably made of one of the materials BK7, SF10, SF11, ZrO₂, fused silica, CrO₂, Si₃N₄, quartz and/or a transparent plastic.

Preferably, an adhesion promoting layer is disposed between the metal layer and the base plate.

This adhesion promoting layer significantly improves the adhesion of the functional metal layer on the transparent carrier. This can be a sufficiently thin film of, for example, titanium or chromium. The adhesion promoting layer is selected thin enough so that it does not interfere with the surface plasmon resonance excitation. Its thickness therefore ranges preferably from 1 nm to 20 nm. A non-metallic cover layer may be applied to the metal layer, e.g. made of glass, metal oxide, semiconductor oxide and/or plastic. This layer is preferably no more than 500 nm thick.

In the wavelength range of 100 nm to 10 μm, at least in a wavelength segment having a width of 10 nm, at a perpendicular angle of incidence, the cover layer preferably has a transmission of <10%.

A surface treatment with, for example, chemical solutions and/or plasmas, can be used to adjust a hydrophilic or hydrophobic surface of the cover layer or the metal film.

Preferably, a biochemical immobilization layer is applied to the metal film or the cover layer.

Advantageously, DNA spots are applied to the metal film or the cover layer. The underside of the base plate advantageously carries a device for the two-dimensional coupling and decoupling of electromagnetic radiation. Such a device can be, for example, a prism. A trapezoidal prism can be made of one or more sections that can be bonded together, if necessary. The angle of incidence of the light changes as a function of the refraction index of the material used for the prisms.

This makes it possible to influence beam guidance, luminance and the optical resolution of the ellipsometer.

The refraction index of the prism should largely correspond to that of the transparent base plate. Between the prism and the base plate, a medium should be introduced, the refraction index of which is likewise as similar as possible. This can be an oil, another suitable liquid or a flexible solid. If a liquid or a viscous medium is used, it can be applied manually or by means of a pump device. The metal layer or layers can be connected to a voltage source. In this case the metal layer also serves as an electrode.

If the metal layer on the transparent carrier is simultaneously used as an electrode, the migration of charged particles in a liquid can be influenced, i.e. accelerated or impeded. For this purpose, a counter-electrode may be provided at another site in the liquid containing the charged particles. The electrodes can have electrical contact with the liquid or can be electrically isolated by non-conductive protective layers, e.g. made of SiO₂.

The metal layer can also be applied partially so as to form a matrix-like structure. In this case, the metallic matrix elements can each be connected to its own voltage source.

For example, the matrix-like electronic structure can be configured in such a way that it is adapted to the matrix-like distribution of the DNA spots on a biochip. The matrix-like, individually arranged electrodes can be supplied with individual leads and individual voltages.

However, the electrodes can also be electrically interconnected, such that only one voltage needs to be applied.

The measuring device according to the invention comprises an ellipsometer, which has a radiation source, a polarizer, an analyzer and a detector as well as an evaluation unit connected to the detector. The measuring device further comprises a sample carrier for the sample or samples to be measured, the base plate of which has at least one metal layer on the side facing the sample. Between the analyzer and the polarizer, an optical coupling and decoupling device is arranged on the sample carrier. This coupling and decoupling device is configured in such a way that the electromagnetic radiation is directed onto the metal layer at an angle of incidence such that a damped surface plasmon resonance is excited. A lens system each is arranged in the beam path, in front of and behind the coupling and decoupling device, which two-dimensionally illuminates the coupling and decoupling device and the detection surface of the detector. The detector is an imaging sensor and thus enables the simultaneous spatially resolved measurement of the measurement signals. The evaluation unit is configured for the spatially resolved simultaneous processing of the (δ cos Δ) values.

The ellipsometer can be a zero ellipsometer, as it is described, for example, in Analytical Chemistry, Vol. 62, No. 17, Sep. 1, 1990, page 889. It can also be an ellipsometer with rotating polarizer or an ellipsometer with rotating analyzer or a phase-modulated ellipsometer.

The imaging sensor is preferably a CCD camera or a matrix-like arrangement of photodiodes or phototransistors.

The radiation source can be polychromatic, with a monochromator with variable wavelength or a filter wheel with optical band pass filters of different wavelengths being arranged between the radiation source and the imaging sensor.

The radiation source can also be a largely monochromatic light source or can consist of a plurality of largely monochromatic individual light sources with different wavelengths.

The lens system for two-dimensional radiation is preferably a Scheimpflug system. A Scheimpflug system is advantageous for the sharp imaging of planes that are not parallel to the detection plane.

The coupling and decoupling device can be a prism made of BK7, SF10, SF11, ZrO₂, fused silica, quartz or a transparent plastic.

The sample carrier can form the bottom of a reaction chamber. The reaction chamber can have a temperature control and/or humidifying system.

All the embodiments regarding the biochips and sample carriers can also be transferred to titer plates.

Exemplary embodiments of the invention will now be described in greater detail with reference to the drawings, in which:

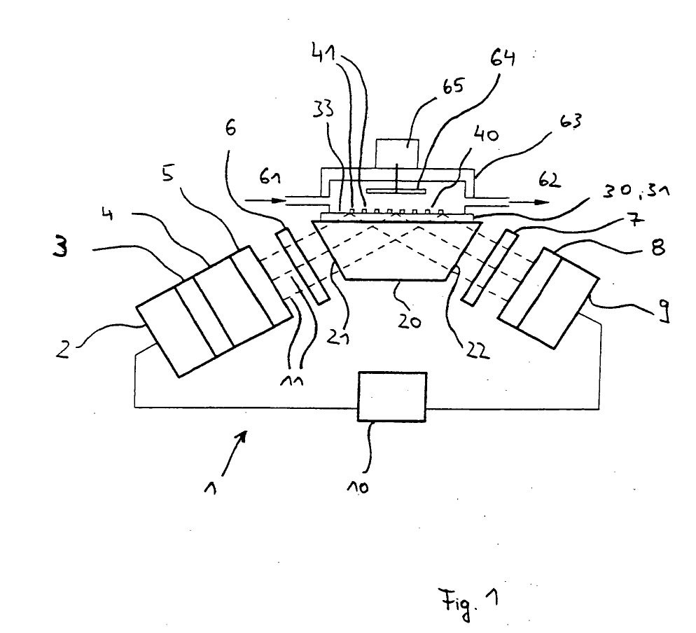

FIG. 1 shows a measuring device according to the invention with a biochip,

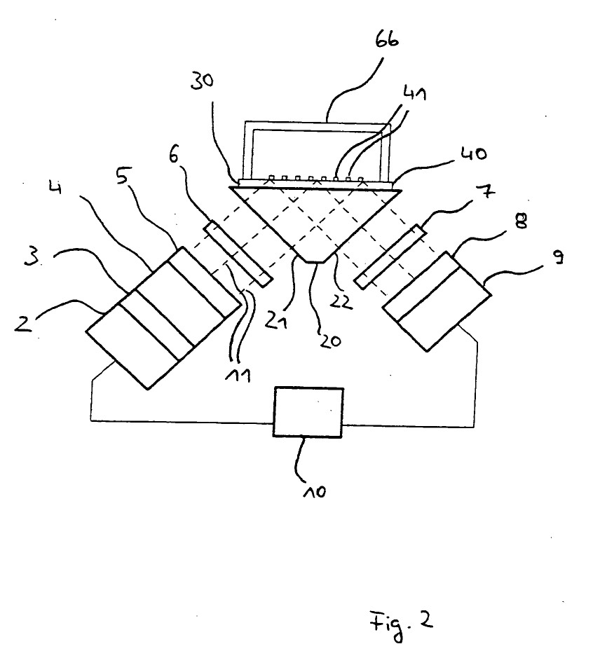

FIG. 2 shows a measuring device according to another embodiment,

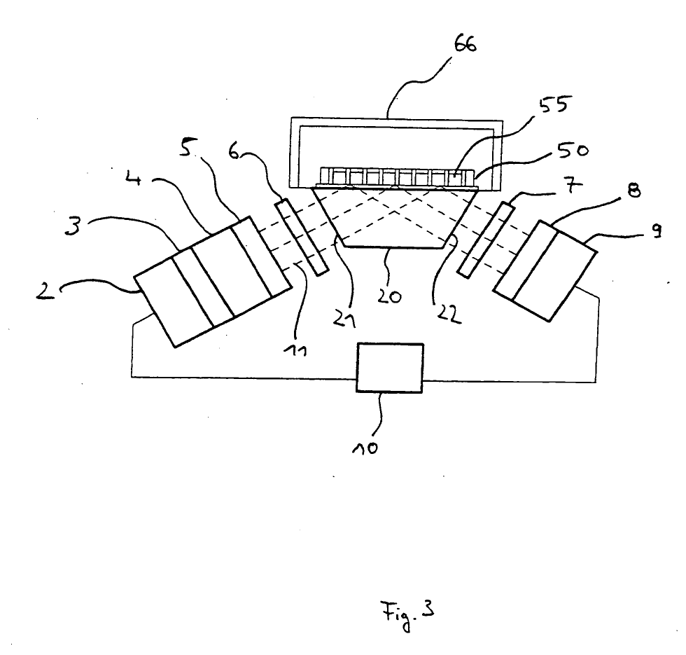

FIG. 3 shows a measuring device according to yet another embodiment with a titer plate,

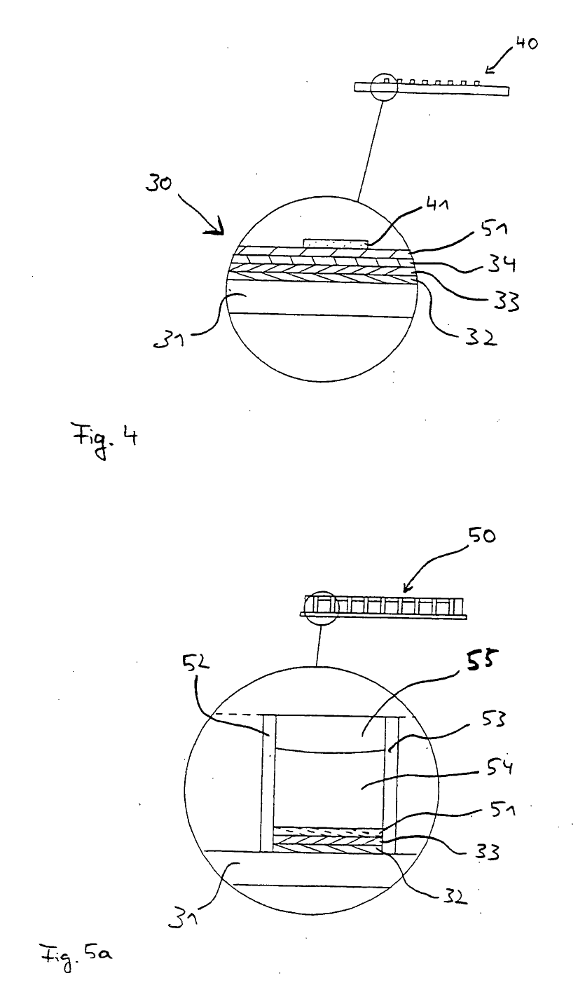

FIG. 4 is an enlarged detail of a biochip,

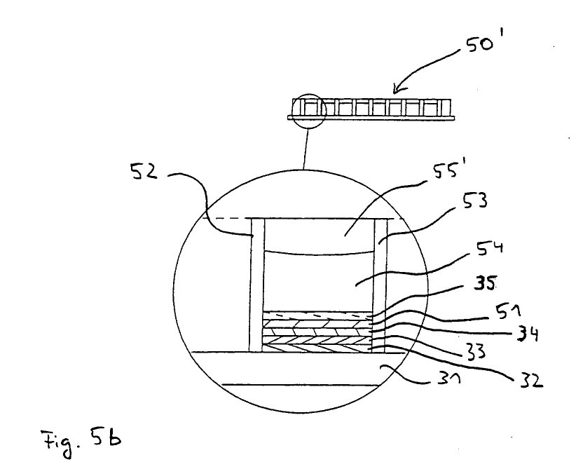

FIG. 5a is an enlarged detail of a microreaction vessel of a titer plate,

FIG. 5b is an enlarged detail of a microreaction vessel of a titer plate,

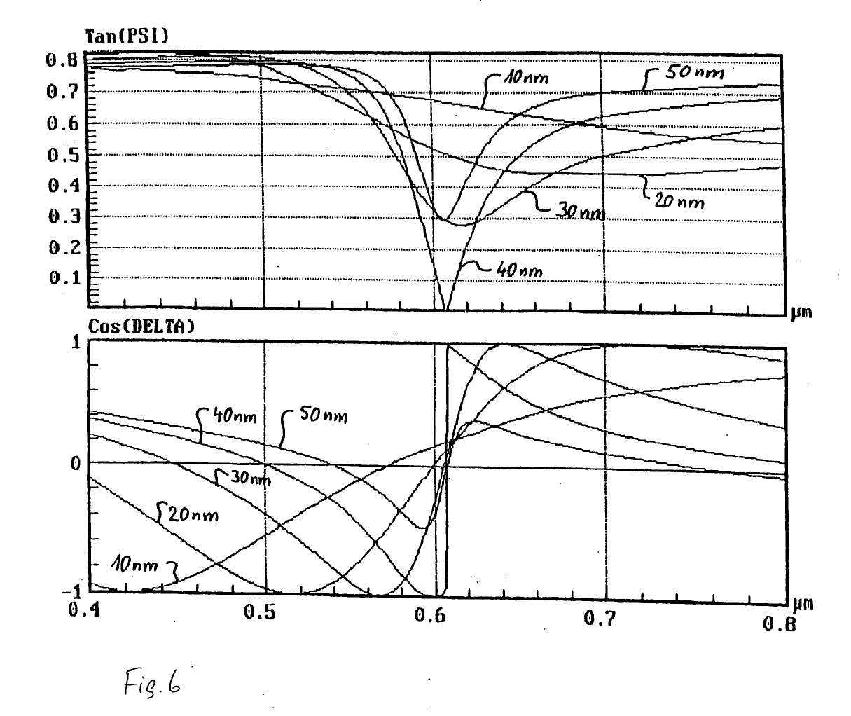

FIG. 6 shows two diagrams to illustrate the adjustment of both the surface plasmon resonance and the thicknesses of the metal layer.

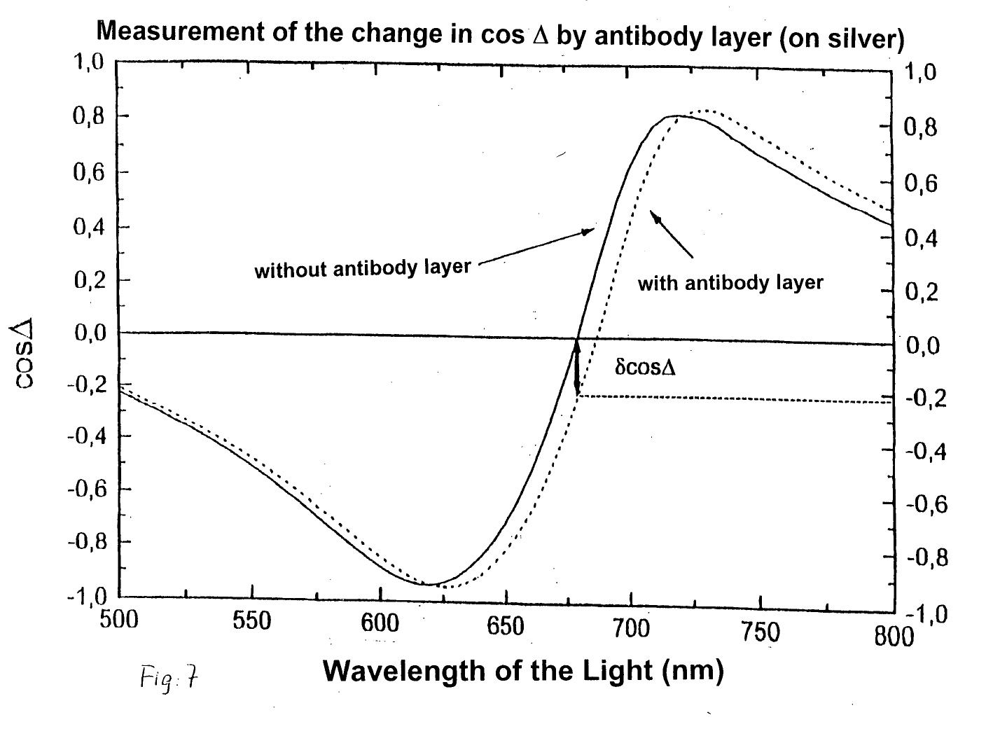

FIG. 7 shows the measurement of the changes in δ cos Δ as a function of the wavelength of the radiated light,

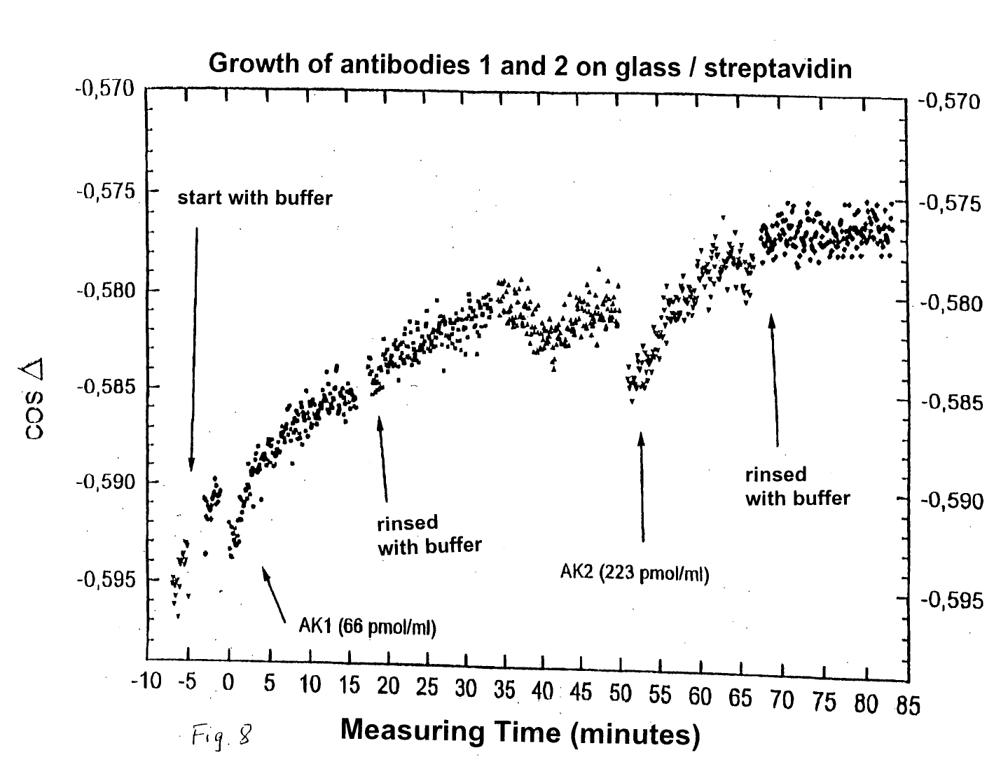

FIG. 8 shows δ cos Δ as a function of the measuring time without metal film,

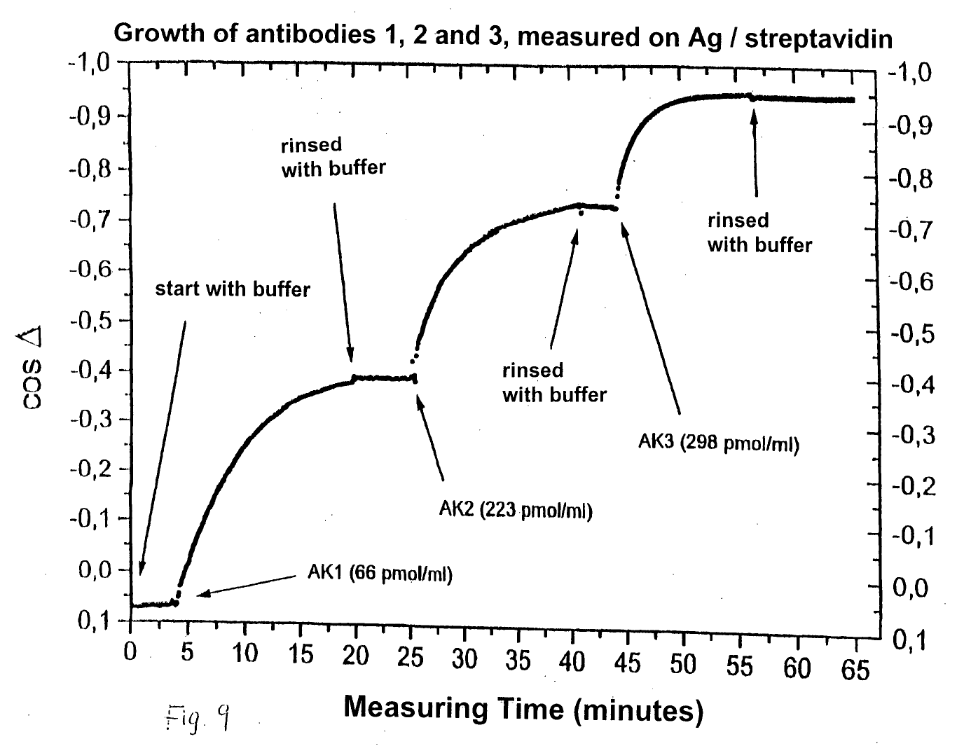

FIG. 9 shows δ cos Δ as a function of the measuring time using a silver film,

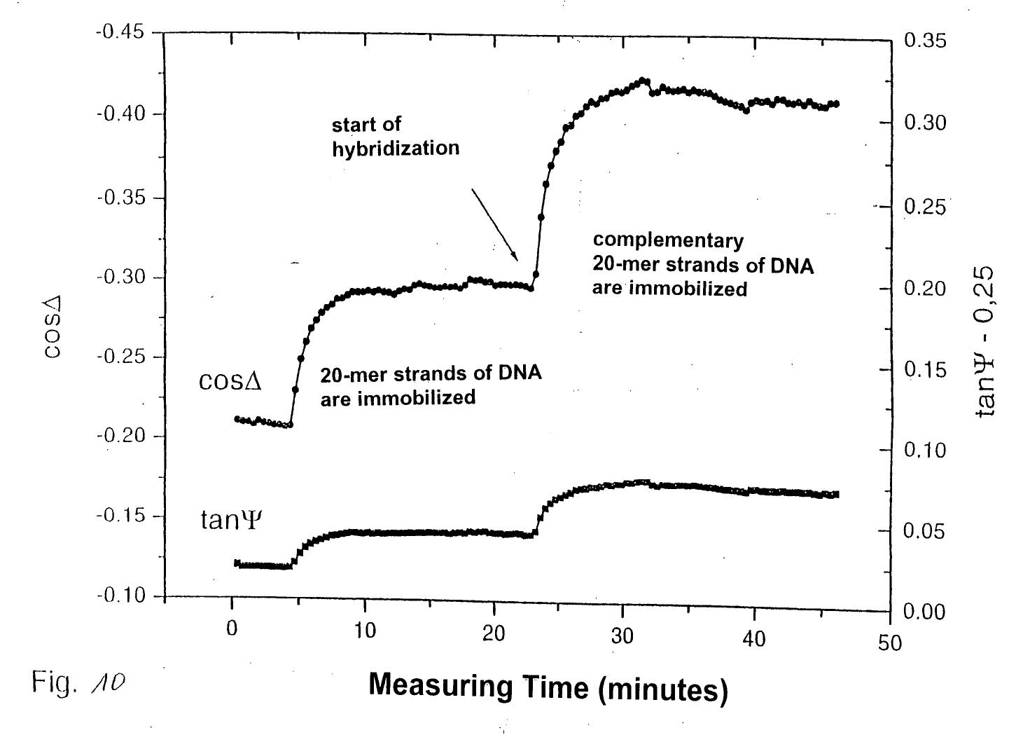

FIG. 10 is a diagram showing δ cos Δ over the measuring time during the hybridization process using a gold film, and

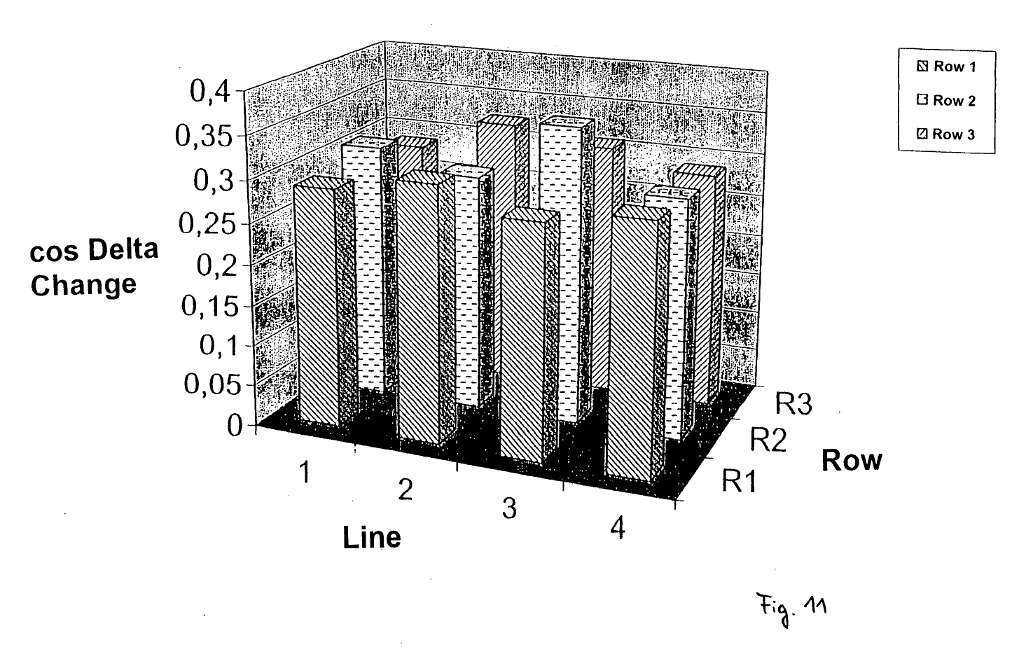

FIG. 11 is a three-dimensional bar diagram illustrating the spatially resolved measurements.

FIG. 1 is a schematic of a measuring device 1. The electromagnetic radiation 11 of a monochromatic light source, e.g. a halogen lamp 2, is adapted to the input window of an optical monochromator 4 (filter wheel or scanning monochromator) using a lens system 3. The radiation 11 leaving the monochromator 4 is parallelized and if necessary expanded using an additional lens system 5.

The monochromatic radiation is linearly polarized using a polarizer 6 and falls vertically onto the input surface 21 of a coupling and decoupling device 20 in the form of a prism. The radiation passes through the input surface 21 with low reflection losses and negligible refraction and falls onto a further prism surface. A thin oil film for adapting the refraction index is disposed between this prism surface and the sample carrier 30 located thereon. The transparent carrier 30 is made of a homogenous glass or plastic material and has a refraction index that is as close as possible to that of the coupling and decoupling device 20.

After the radiation has passed through the base plate 31 of the sample carrier 30, it is reflected on the metal film 33 and because of the excitation of a damped surface plasmon resonance is weakened in its intensity and changed with respect to its phase or polarization. The reflected radiation strikes a rotating analyzer 7 used to determine the reflection-associated intensity and phase changes for the s- and p-components (components polarized perpendicular and parallel to the plane of incidence) of the radiation. The radiation then passes through a lens system 8, preferably a Scheimpflug system, by means of which it is imaged on the imaging sensor 9 in the form of a CCD camera. The imaging sensor 9 relays its signals to an evaluation and control device 10, which further processes the signals and also coordinates the entire measurement process.

In the example shown here, the ellipsometric measuring device is used to analyze a biochip 40 with matrix-like DNA spots 41 with different base sequences. The DNA spots 41 are immobilized on the metal layer 33 and surrounded by an aqueous solution. The aqueous solution can be replaced via an inflow 61 and an outflow 62. To accelerate hybridization processes or other biological interactions, an agitator 65 with an associated drive is provided. The aqueous liquid can be adjusted to a fixed temperature or can be cooled or heated during the measurement using a temperature control system 63. The ellipsometric values tan ψ and δ cos Δ are determined spatially resolved for a plurality of radiation wavelengths in the range of the damped surface plasmon resonance. Using a suitable evaluation software, the strength of the biological interactions at the different DNA spots 41 is determined from the ellipsometric measurement data.

FIG. 2 shows a measuring device according to another embodiment, which is distinguished from the arrangement depicted in FIG. 1 in that the DNA spots 41 on the biochip 40 are not surrounded by an aqueous but by a gaseous medium, e.g. air, nitrogen or argon. Because the refraction index of gaseous media is low compared to aqueous media, a small angle of incidence is provided for the electromagnetic radiation, so that a damped surface plasmon resonance can be excited in the same spectral range. Biochemical substances are generally more stable in a gaseous environment if the humidity is high. A humidifying system 66 is therefore provided in addition to the temperature control system.

FIG. 3 shows yet another embodiment of a measuring device 1, which is distinguished from the measuring device depicted in FIG. 1 in that a titer plate 50 with a matrix-like arrangement of indentations (cuvettes 55) is analyzed instead of a biochip 40. Because of the large dimensions of the titer plate, the prism and all other components are likewise made correspondingly larger. The cuvettes 55 are filled with a liquid. The remaining temperature-controlled space, however, is filled with a gaseous medium. To guard against evaporation, a humidifying system 66 is again provided in addition to the temperature-control system.

FIG. 4 is an enlarged detail of an area of a biochip 40 in the region of a spot 41. The layer structure of the biochip 40 consists of a base plate 31, an adhesion promoting layer 32, a metal layer 33, a cover layer 34, an immobilization layer 51 and one or more spots 41 applied thereto.

The base plate 31 can be, e.g., an ordinary microscope slide. The base plate 31 is typically about 1 mm thick. The refraction index of the base plate is adjusted to that of the prism of the coupling and decoupling device 20. The adhesion-promoting layer 32, e.g. made of titanium or chromium, is between 1.5 and 15 nm thick.

The 20 nm to 30 nm thick metal layer 33 is made of gold and is applied to the adhesion-promoting layer 32. The thickness of the gold layer 33 is a special feature that distinguishes this biochip from other gold-coated biochips. Conventional gold-coated biochips usually have a gold layer of 50 nm or more. For the method according to the invention, however, a gold layer thickness of between 20 and 30 nm is optimal. The metal layer or layers are preferably applied by vapor deposition or sputtering.

On the metal layer 33, there is a matrix-like arrangement of DNA spots 41 with different base sequences. There can be up to 500,000 DNA spots 41 per cm². The DNA strands are immobilized on the chip, e.g. by injecting droplets (spotting), by photolithography or by using the phosphoramide method. For storage, the DNA spots can be provided with a soluble biochemical protective layer that protects them against denaturation.

FIG. 5a shows a titer plate 50 and an enlarged detail in the area of a microreaction vessel 55. The titer plate 50 is distinguished from a conventional, commercially available titer plate in that the inside of the microreaction vessels 55 of the base plate 31 is provided with a gold layer 33 that is applied to an adhesion promoting layer 32. The adhesion promoting layer is 1.5 nm to 15 nm thick, while the gold layer is 20 nm to 30 nm thick. The transparent bottoms of the microreaction vessels can be made of plastic or glass. The thickness of the base plate 31 typically ranges from 0.1 mm to 1 mm. The bottoms are either a fixed component of a titer plate molded from plastic or parts of a glass or plastic plate that is bonded to a titer plate without bottom. The refraction index of the bottoms is adjusted to that of the prism of the coupling and decoupling device. The underside of the titer plate, which is placed onto the coupling and decoupling device, is unstructured and smooth.

Applied to the gold layer 33 is a biochemical layer 51 with capture molecules that can be immobilized on the gold using biotin-streptavidin bonds or thiol chemistry. The layer 51 is thus an immobilization layer. The different microreaction vessels can contain the same or different capture molecules. These capture molecules are, for example, antibodies, single strand DNA, proteins, peptides or more complex structures, such as viruses or bacteria. For storage, the capture molecules can be provided with a soluble biochemical protective layer that protects them against denaturation. During measurement, the microreaction vessels contain a liquid.

The upper part of FIG. 6 shows tan ψ and the lower part cos Δ, each as a function of the radiated wavelength. To adjust the surface plasmon resonance, the unpolarized light is directed onto the underside of the bottom wall of a cuvette at an angle of incidence of, e.g., 70°, as shown in FIG. 5b by way of example. Through the excitation of the surface plasmon resonance in the metal layer 5, a distinct minimum, which is associated with a steep edge of the corresponding cos Δ curve, is established for tan ψ at a specific wavelength.

After the wavelength for the excitation of the surface plasmon resonance has been determined in this manner, a further optimization is performed by means of adjusting the thickness of the metal layer. For both tan ψ and cos Δ, 5 curves are plotted for the thicknesses 10 nm, 20 nm, 30 nm, 40 nm and 50 nm. The curves are applicable to a metal layer made of silver; similar values are obtained for a gold layer. It is clear that with layer thicknesses of 10 nm and 50 nm, the cos Δ curves are flat and the minimums of tan ψ are not very distinct. Thinner metal layers are especially suitable for determining relatively thick biological layers. For metal layer thicknesses of <10 nm, however, the resulting sensitivities are rather too low. Metal layer thicknesses ≧50 nm are less suitable for the method according to the invention because of the small dynamic range. Only the curves for the thicknesses of 20 to 40 run show a steep slope and thus high detection sensitivity, with the entire dynamic range between −1 and +1 being utilized.

After optimizing the wavelength, the angle of incidence and the thickness of the metal layer, measurements were taken of the samples as shown in FIGS. 7 to 9.

FIG. 7 shows cos Δ as a function of the wavelength of the radiated light. The solid curve on the left shows measurements without antibodies while the dotted curve indicates measurements with antibodies. The measurements were taken on cuvettes with glass bottoms whose bottom wall is provided with a 12 nm thick titanium layer, a 27 nm thick silver layer and a 17 nm thick streptavidin layer as the immobilization layer. The angle of incidence of the light is 70°. After an interaction period of 10 min, a 2.5 nm thick antibody layer grows, which is detected by the shift of the cos Δ curve. The spectral measurements serve to determine the optimal wavelength with respect to the detection sensitivities of the dynamic range. In the present case, an optimal wavelength range of 640 to 700 nm resulted. If a single-wavelength measurement is taken at e.g. 680 nm, an increase in the thickness of the antibody layer approximately proportional to the change in the cos Δ value can be measured as a function of the incubation time of the antibody solution. After an increase in the antibody layer by 2.5 nm, the cos Δ value has changed by approximately 0.2. The resulting detection sensitivity (|δ cos Δ|/layer thickness) is 0.08/nm. This detection sensitivity is greater by more than one order of magnitude than that which is obtainable with “conventional ellipsometry” (e.g. with a metallic substrate).

FIG. 8 shows cos Δ as a function of the measuring time. This is a comparison measurement in which the metal layer on the bottom wall of the cuvette was absent. The arrows mark the instants when an aqueous buffer solution or an antibody-containing aqueous solution was used at a concentration of 66 pmol/ml and, respectively, 223 pmol/ml (see FIG. 8).

As soon as the antibodies are added, the cos Δ curve rises as a function of the measuring time. This rise, however, can be hardly distinguished from cos Δ changes that occur due to thermal drifts in the absence of antibodies (buffer solution only).

The scattering of the measuring points is substantial, and it was found that clearly better results are achieved with the use of a silver or gold layer on the inside of the bottom wall, as illustrated in FIG. 9. The value range of cos Δ passes from 0.05 to −0.95, while the value range according to FIG. 8 extends only from −0.57 to −0.595. Thus, it is clear that by providing the metal layer and by adjusting the surface plasmon resonance it is possible to obtain clearly greater signal heights and not just an improvement of the signal-to-noise ratio, which can be achieved simply by longer measuring times.

FIG. 10 shows a diagram illustrating the detection of DNA hybridizations. The detected individual strands of the DNA molecules have a mass of approximately 6 k dalton and are thus clearly smaller and more difficult to detect than, for example, antibodies (typically 150 k dalton). The determined thickness of the hybridized DNA layer of approximately 2 nm leads to a cos Δ change of 0.2. Such a large ratio of the cos Δ change to the change in layer thickness is achieved with no other known ellipsometric device. With the ellipsometer used, the cos Δ change of 0.2 was above the detection limit by approximately a factor of 100. With an optimized ellipsometer it is possible to achieve even lower detection limits and thus greater sensitivity. The value 0.25 was deducted from the tan ψ scale for reasons of representation.

FIG. 11 is a three-dimensional representation of a simultaneous spatially resolved measurement. A simultaneous, spatially resolved measurement was taken on a titer plate (1536 format). The number of the simultaneously measured cuvettes was 12. The adhesion-promoting layer was made of 10 nm thick titanium. The metal layer was 25 nm gold. The bar diagram shows a differentiation measurement upon a change in the ion concentration:

Measurement 1: NACL solution 0.25 molar

Measurement 2: NACL solution 0.63 molar

The bar height corresponds to cos Δ₁-cos Δ₂. The corresponding change in the refraction index in the solution was 0.004. The wavelength used was 680 nm and the angle of incidence was 70°.

The individual bars in the diagrams are associated with individual cuvettes of the titer plate. The measurement shows that the method according to the invention can be used for simultaneous spatially resolved measurements of small changes in the refraction index (in this case a liquid).

### REFERENCE NUMERALS

1 measuring device

2 radiation source

3 lens system

4 monochromator

5 lens system

6 polarizer

7 analyzer

8 lens system

9 detector

10 evaluation unit

11 light beam

20 coupling and decoupling device

21 input area

22 output area

23 prism

30 sample carrier

31 base plate

32 adhesion promoting layer

33 metal layer

34 cover layer

35 biochemical layer

40 biochip

41 DNA spot

50 titer plate

51 immobilization layer

52 53 sidewall

54 liquid

55 microreaction vessel

60 reaction chamber

61 inflow

62 outflow

63 temperature control system

64 agitator

65 agitator drive

66 humidity control system

1. Method for quantitative and/or qualitative determination of sample variations due to chemical, biological, biochemical or physical effects based on a change in the refraction index and/or a change in the layer thickness of the sample, wherein the sample is located on a sample carrier that is provided with at least one metal layer, using ellipsometric measurements in which the ellipsometric parameters ψ and Δ are determined, wherein
the angle of incidence and/or the frequency of the electromagnetic radiation used for the ellipsometric measurements is adjusted in such a way that a damped surface plasmon resonance is excited in the metal layer,
the detection sensitivity (δ cos Δ)/(sample change unit) is adjusted via the thickness of the metal layer,
the electromagnetic radiation is two-dimensionally applied to the side of the sample carrier opposite the sample, and
at least two time-staggered, simultaneous, spatially resolved ellipsometric measurements of the sample or samples are taken using at least one angle of incidence and at least one frequency and at least the correspondingly associated Δ and cos Δ values are evaluated to determine the sample variation.

2. Method as claimed in claim 1, characterized in that the simultaneous, spatially resolved ellipsometric measurements are taken during as well as before and/or after the sample variation.

3. Method as claimed in claim 1, characterized in that continuous simultaneous spatially resolved ellipsometric measurements are taken at least during a time segment of the sample variation and at least the change over time of the associated local cos Δ values is analyzed.

4. Method as claimed in any one of claims 1 to 3, characterized in that the thickness of the metal layer is adjusted to between 10 and 45 nm, particularly between 20 and 40 nm.

5. Method as claimed in any one of claims 1 to 4, characterized in that the ellipsometric measurements are taken on a still or flowing medium.

6. Method as claimed any one of claims 1 to 5, characterized in that the electromagnetic radiation is used in the wavelength range of 100 nm to 10 μm, preferably 300 nm to 3 μm.

7. Method as claimed in any one of claims 1 to 6, characterized in that the simultaneous spatially resolved ellipsometric measurements are taken on a biochip that is provided with a plurality of spots.

8. Method as claimed in any one of claims 1 to 7, characterized in that the simultaneous spatially resolved ellipsometric measurements are taken on a plurality of microreaction vessels of a titer plate.

9. Use of the method as claimed in any one of claims 1 to 8 for examining biochemical interactions based on DNA or RNA hybridization, DNA or RNA protein interactions, DNA or RNA antibody interactions or antibody-antigen interactions.

10. Use of the method as claimed in any one of claims 1 to 8 for measuring the shrinkage or swelling of polymer layers.

11. Biochip with a sample carrier comprising a base plate provided with at least one metal layer, characterized in that the sample carrier (30) is made of a material which, in the electromagnetic wavelength range of between 100 nm and 10 μm, at least in a wavelength segment having a width of at least 10 nm, has a transmission of at least 20%, and
the metal layer (33) is made of copper, silver, gold or aluminum or an alloy containing at least 5% by weight of at least one of these metals, wherein the thickness of the metal layer (33) or the total thickness of several metal layers is between 10 and 45 nm, particularly between 20 and 40 nm.

12. Biochip as claimed in claim 11, characterized in that the base plate (31) is made of one of the materials BK7, SF10, SF11, ZrO₂, fused silica, quartz and/or a transparent plastic.

13. Biochip as claimed in claim 11 or 12, characterized in that an adhesion promoting layer (32) is arranged between the metal layer (33) and the base plate (31).

14. Biochip as claimed in claim 12, characterized in that the adhesion promoting layer (32) is made of titanium or chromium and is 1 nm to 20 nm thick.

15. Biochip as claimed in any one of claims 11 to 14, characterized in that a non-metallic cover layer is applied to the metal layer (33).

16. Biochip as claimed in claim 15, characterized in that the non-metallic cover layer (34) is made of glass, metal oxide, semiconductor oxide and/or plastic.

17. Biochip as claimed in any one of claims 15 or 16, characterized in that the non-metallic cover layer (34) is at maximum 500 nm thick.

18. Biochip as claimed in any one of claims 15 to 17, characterized in that, in the wavelength range of 100 nm to 10 μm, at least in a wavelength segment having a width of 10 nm, at a perpendicular angle of incidence, the cover layer (34) has a transmission greater than 10%.

19. Biochip as claimed in any one of claims 11 to 18, characterized in that the metal layer (33) or the cover layer (34) has a hydrophilic or hydrophobic surface.

20. Biochip as claimed in any one of claims 11 to 19, characterized in that a biochemical immobilization layer (51) is applied to the metal layer (33) or the cover layer (34).

21. Biochip as claimed in any one of claims 11 to 19, characterized in that DNA spots (41) are applied to the metal layer (33) or the cover layer (34).

22. Biochip as claimed in any one of claims 11 to 21, characterized in that the underside of the base plate (31) carries a device (20) for the two-dimensional coupling and decoupling of electromagnetic radiation.

23. Biochip as claimed in claim 22, characterized in that an immersion liquid is provided between the coupling or decoupling device (20) and the base plate (31).

24. Biochip as claimed in claim 22, characterized in that a flexible layer for adjusting the refraction index is arranged between the base plate (31) and the coupling and decoupling device (20).

25. Biochip as claimed in any one of claims 11 to 24, characterized in that the metal layer (33) is connected to a voltage source.

26. Biochip as claimed in any one of claims 11 to 25, characterized in that the metal layer (33) is applied partially so as to form a matrix-like structure.

27. Biochip as claimed in claim 26, characterized in that each metallic matrix element is connected to its own voltage source.

28. Measuring device with an ellipsometer comprising a radiation source, a polarizer, an analyzer and a detector as well as an evaluation unit connected to the detector, with a sample carrier for the sample or samples to be measured whose base plate has at least one metal layer on the side facing the sample, and with an optical coupling and decoupling device arranged on the sample carrier between the analyzer and the polarizer, wherein the coupling and decoupling device is configured in such a way that the electromagnetic radiation is directed onto the metal layer at an angle of incidence such that a damped surface plasmon resonance is excited, characterized in that a lens system (5,8) is disposed, respectively, in the beam path in front of and behind the coupling and decoupling device (20) for the two-dimensional illumination of the coupling and decoupling device (20) and the detection surface of the detector (9),
the detector (9) is an imaging sensor, and
the evaluation unit (10) is configured for the spatially resolved simultaneous processing of the measuring signals and at least for the spatially resolved simultaneous evaluation of the (δ cos Δ) values.

29. Measuring device as claimed in claim 28, characterized in that the ellipsometer is a null ellipsometer, an ellipsometer with rotating polarizer, an ellipsometer with rotating analyzer or a phase-modulated ellipsometer.

30. Measuring device as claimed in claim 28 or 29, characterized in that the imaging sensor is a CCD camera or a matrix-like arrangement of photodiodes or phototransistors.

31. Measuring device as claimed in any one of claims 28 to 30, characterized in that the radiation source (2) is polychromatic and a monochromator (4) with variable wavelength or a filter wheel with optical band pass filters of various wavelengths is arranged between the radiation source (2) and the imaging sensor.

32. Measuring device as claimed in any one of claims 28 to 30, characterized in that the radiation source (2) is a largely monochromatic light source or comprises a plurality of largely monochromatic individual light sources with different light wavelengths.

33. Measuring device as claimed in any one of claims 28 to 32, characterized in that the lens system (8) is a Scheimpflug system.

34. Measuring device as claimed in any one of claims 28 to 33, characterized in that the coupling or decoupling device (20) is a prism made of BK7, SF10, SF11, ZrO₂, fused silica, CrO₂, Si₃N₄, quartz or a transparent plastic.

35. Measuring device as claimed in any one of claims 28 to 34, characterized in that the sample carrier (30) forms the bottom of a reaction chamber (60).

36. Measuring device as claimed in claim 35, characterized in that the reaction chamber (60) has a temperature control system (63).

37. Measuring device as claimed in any one of claims 35 or 36, characterized in that the reaction chamber (60) has a humidity control system (66).
